(19) United States
(12) Patent Application Publication
(10) Pub. No.: US 2011/0046033 A1
(43) Pub. Date: Feb. 24, 2011

(54) Multipurpose Lens Care Solution with Benefits to Corneal Epithelial Barrier Function

(76) Inventor: Jinzhong Zhang, Pittsford, NY (US)

Correspondence Address: Bausch & Lomb Incorporated, One Bausch & Lomb Place, Rochester, NY, 14604-2701, US

(21) Appl. No.: 12/939,262

(22) Filed: Nov. 4, 2010

Related U.S. Application Data
(63) Continuation-in-part of application No. 12/023,509, filed on Jan. 31, 2008.

(51) Int. Cl. C11D 3/60; C11D 3/48

(52) U.S. Cl. 510/112

(57) ABSTRACT

A multipurpose lens care solution comprising 0.005 wt. % to 1 wt. % of an anionic biopolymer, and an antimicrobial agent selected from 0.5 ppm to 2 ppm of poly(hexamethylene biguanide), 0.5 ppm to 2 ppm polyquaternium-1, or 1 ppm to 4 ppm alexidine. The lens care solution exhibits a ZO-1 immunostaining of HCEpiC similar to phosphate buffered saline for after thirty minutes of contact time with the solution. The lens care solution will also have a transepithelial electrical resistance (TEER) of HCEpiC within a 25% difference or less than phosphate buffered saline in Ohm/cm² after one hour of contact time with a 3:1 dilution (solution:DMEM), or the ECIS electrode arrays exhibit a 25% difference or less than phosphate buffered saline in Ohm after one hour of contact time with a 1:1 dilution (solution:DMEM).

This is a continuation-in-part application of U.S. patent application Ser. No. 12/023,509 filed Jan. 31, 2008, the entire disclosure of which is incorporated herein by reference.

The present invention relates to multipurpose lens care solutions and the use of the solutions to clean and disinfect contact lenses.

### BACKGROUND OF THE INVENTION

An important role of the corneal epithelium is to maintain a functional barrier between the external and internal ocular environments. Epithelial barrier function is maintained by the unique membrane structure which consists of the tight junction, adherens junction and desmosome. Of these three structures, the tight junction is the most apical and forms a high resistance barrier, therefore preventing free diffusion of ions and solutes. Tight junctions are composed of a complex of proteins including transmembrane proteins occludin and claudin and cytoplasmic proteins such as the zonula occludens ZO-1, ZO-2 and ZO-3 which interact with both the transmembrane proteins and the actin cytoskeleton. Together these proteins form a tight contact between the plasma membrane of adjacent cells. See, Nusrat A. et al, Am. J. Physiol. Gastrointest. Liver Physiol. 2000, 279. G851; Hartsock A. et al., Biochim. Biophys. Acta. 2008, 1778, 660; and Anderson J. M., News Physiol. Sci. 2001, 16, 126.

Loss of epithelial barrier function occurs due to increased contractility and disruption of actin filaments and breakdown of tight junction proteins such as ZO-1, occludin, and ZO-2. This disruption of corneal barrier function can cause ocular irritation and may be a risk factor for microbial infections. See, Pflugfelder S. C. et al., Am. J. Pathol. 2005, 166, 61; Yokoi N., Kinoshita S. Cornea 1995, 14, 485; and Fleiszig S. M et al., Infect. Immun. 1997, 65, 2861.

Multipurpose contact lens solutions (MPSs) are used in the cleaning and disinfection of contact lenses. MPSs consist of antimicrobial agent for disinfectant and preservative qualities, a surfactant, a chelator which may have antibiotic properties, wetting agents, and a buffering agent to maintain pH of the solution. Presently, the three most popular antimicrobial agents are poly(hexamethylene biguanide), at times referred to as PHMB or PAPB, alexidine and polyquaternium-1. These agents must be efficacious in killing microbes but since they are routinely introduced into the eye they must also be biocompatible with the ocular surface.

An in vitro assessment of junction protein expression and distribution on the cell surface and electrical resistance across monolayers of human corneal epithelial cells allows direct measurement of the effect of an MPS on corneal epithelial integrity and barrier function. This measurement is especially important in the development of a new MPS.

### SUMMARY OF THE INVENTION

A multipurpose lens care solution comprising 0.005 wt. % to 1 wt. % of an anionic biopolymer, and an antimicrobial agent selected from 0.5 ppm to 2 ppm of poly(hexamethylene biguanide), 0.5 ppm to 3 ppm polyquaternium-1, 1 ppm to 4 ppm of alexidine, or any one mixture thereof. The lens care solution exhibits a ZO-1 immunostaining of HCEpiC similar to phosphate buffered saline for after thirty minutes of contact time with the solution. The lens care solution will also have a transepithelial electrical resistance (TEER) of HCEpiC within a 25% difference or less than phosphate buffered saline in Ohm/cm² after one hour of contact time with a 3:1 dilution (solution:DMEM), or the ECIS electrode arrays exhibit a 25% difference or less than phosphate buffered saline in Ohm after one hour of contact time with a 1:1 dilution (solution:DMEM).

### DESCRIPTION OF THE FIGURES

FIG. 1 is a bar graph showing the stand-alone biocidal efficacy of tested MPSs tested at designated intervals to determine the stability of the formulation with time for is disinfection activity.

FIG. 2 shows confocal laser scanning micrographs of human corneal epithelial cells stained with ZO-1 antibody (white web-like pattern) and counter-stained with propidium iodide (gray bodies) (original magnification, 40×).

FIG. 3 is a plot of the tested MPSs on transepithelial electrical resistance (TEER) measurements in HCEpiC.

FIG. 4 is a time course effect of MPSs on HCEpiC monolayer resistance.

### DETAILED DESCRIPTION OF THE INVENTION

Applicants and others at Bausch & Lomb have developed and tested numerous ophthalmic formulations for use as MPSs. MPSs must satisfy a number of functional characteristics. First, the MPS must possess the cleaning ability to remove denatured tear proteins and tear lipids as well as other external contaminants. Second, the MPS must possess significant disinfecting ability against a number of different bacteria and fungal strains. Third, the MPS must remain comfortable to the contact lens patient with minimal stinging as well as provide a platform to provide additional comfort or protection to the ocular surface. Fourth, the MPS must not cause significant shrinkage or swelling of the many different contact lens materials, which in turn can lead to loss in visual acuity or undesired lens movement on the cornea. The ophthalmic compositions described and claimed address each of these functional requirements as well as other important characteristics described in greater detail herein.

Applicant's developmental program and their investigations of numerous MPSs led to at least three important insights. One, formulations that contain an anionic biopolymer, and in particular, hyaluronic acid, tend to exhibit less superficial punctate staining at the two-hour point than those formulations that do not contain the anionic biopolymer. Two, the anionic biopolymer appear to interact with the cationic-charged antimicrobial components, and in particular, both PHMB and polyquaternium-1. The result is a lens care solution that exhibits exceptional biocidal activity and biocidal stability with minimal or little impact on the observed benefits that the anionic biopolymers provide.

With the above in mind, the invention is directed to a multipurpose lens care solution comprising 0.005 wt. % to 1 wt. % of an anionic biopolymer, and an antimicrobial agent selected from 0.5 ppm to 3 ppm of poly(hexamethylene biguanide), 0.5 ppm to 2 ppm polyquaternium-1, or 1 ppm to 4 ppm of alexidine, or any one mixture thereof. The lens care solution exhibits a ZO-1 immunostaining of HCEpiC similar to phosphate buffered saline for after thirty minutes of contact time with the solution. The lens care solution will also have a transepithelial electrical resistance (TEER) of HCEpiC within a 25% difference or less than phosphate buffered saline in Ohm/cm² after one hour of contact time with a 3:1 dilution (solution:DMEM), or the ECIS electrode arrays exhibit a 25% difference or less than phosphate buffered saline in Ohm after one hour of contact time with a 1:1 dilution (solution:DMEM).

In order for a MPS to be approved for sale in the United States, the composition must possess a requisite level of disinfection efficacy known as “ISO Stand Alone Procedure for Disinfecting Products”, hereafter “ISO Biocidal”. ISO Biocidal sets a log-kill of three (3.0) or greater against three bacterium; Staphylococcus aureus, Pseudomonas aeruginosa, and Serratia mancescens. ISO Biodical also sets a log-kill of one (1.0) or greater against two fungi, Candida albicans and Fusarium solani. Of course, there is a limit as to how much disinfecting agent can be put into a MPS because the solution will come in direct contact with ocular tissues and cells when one places a clean and disinfected contact lens onto the eye. Following disinfection of a contact lens with a MPS, a patient is instructed to remove the lens from the lens case, and without having to rinse the lens, the patient inserts the lens onto the eye. Accordingly, in the development of a MPS one must balance disinfection efficacy (i.e., place concentration limits on disinfection agents) with ocular comfort and safety.

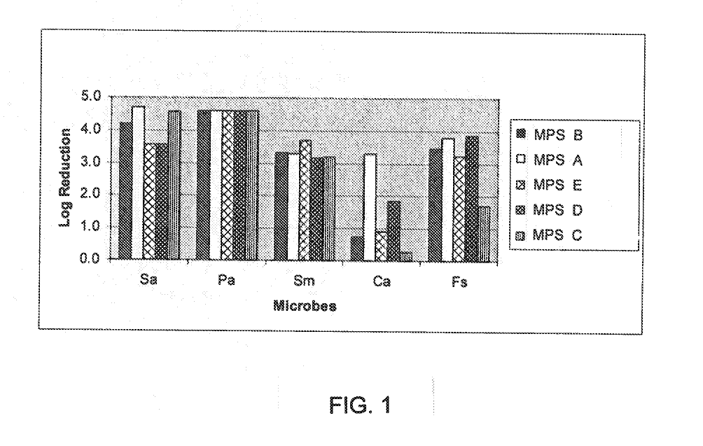

To access the biocidal efficacy of the inventive MPSs Applicants conducted comparative tests of an inventive MPS against four (4) MPSs marketed in the United States and Europe. The inventive MPS tops each of four MPSs in terms of biocidal log-kill when accessed across all five microorganisms, FIG. 1. For reference, Table 1 below lists the leading MPS in the U.S. and European markets with their respective disinfectants (concentration in ppm).

TABLE 1

| MPS | PQ-1 | PHMB |
|---|---|---|
| OF Replenish ® ^{a} (MPS E) | 10 | — |
| OF Express ® ^{a} (MPS D) | 10 | — |
| Complete ® (MPS C) | — | 1.0 |
| Aquify ® (MPS B) | — | 1.0 |
| Example 1 (MPS A) | 1 | 1.3 |

^{a} MPS also contains Aldox ® (myristamidopropyl demethylamine) to assist in log-kill for the fungi.

Upon review of the biocidal data of FIG. 1 a person of skill is immediately directed to the biocidal efficacy against Candida albicans. The biocidal superiority against Candida albicans observed with Example 1 (MPS A) is quite unique because of the five listed test organisms “Candida albicans is often the most resistant of the five organisms to commonly used cationic antimicrobial agents in contact lens multi-purpose solutions [MPS]. Thus, achievement of adequate antimicrobial activity against Candida is often the most difficult task to pass a particular disinfection efficacy standard.” U.S. Pat. No. 7,578,996, column 11, lines 18-25, which is assigned to Abbott Medical Optics, the manufacturer of Complete® MPS (MPS C). By looking again at the Table of Competitor MPSs in FIG. 1., one finds that Example 1 (MPS A) possesses a three (3) log-kill or greater or is about 1000× more effective against Candida than Complete® (MPS C with 1 ppm PHMB). The same person also finds that Example 1 (MPS A) possesses a two (2) log-kill or greater or is about 100× more effective against Candida than MPS B with 1 ppm PHMB, or MPS E with 10 ppm polyquaternium-1 and an additional antifungal agent, Aldox®.

Hyaluronic acid is a linear polysaccharide (long-chain biological polymer) formed by repeating disaccharide units consisting of D-glucuronic acid and N-acetyl-D-glucosamine linked by β(1-3) and β(1-4) glycosidic linkages. Hyaluronic acid is distinguished from the other glycosaminoglycans, as it is free from covalent links to protein and sulphonic groups. Hyaluronic acid is ubiquitous in animals, with the highest concentration found in soft connective tissue. It plays an important role for both mechanical and transport purposes in the body; e.g., it gives elasticity to the joints and rigidity to the vertebrate disks, and it is also an important component of the vitreous body of the eye.

Hyaluronic acid is accepted by the ophthalmic community as a compound that can protect biological tissues or cells from compressive forces. Accordingly, hyaluronic acid has been proposed as one component of a viscoelastic ophthalmic composition for cataract surgery. The viscoelastic properties of hyaluronic acid, that is, hard elastic under static conditions though less viscous under small shear forces enables hyaluronic acid to basically function as a shock absorber for cells and tissues. Hyaluronic acid also has a relatively large capacity to absorb and hold water. The stated properties of hyaluronic acid are dependent on the molecular weight, the solution concentration, and physiological pH. At low concentrations, the individual chains entangle and form a continuous network in solution, which gives the system interesting properties, such as pronounced viscoelasticity and pseudoplasticity that is unique for a water-soluble polymer at low concentration.

Alginate is an anionic biopolymers produced by a variety of microorganisms and marine algae. Alginate is a polysaccharide that comprises β-D-mannuronic acid units and α-L-guluronic acid units. Some alginate polymers are block copolymers with blocks of the guluronic acid (or salt) units alternating with blocks of the mannuronic acid (or salt) units as depicted in-part below.

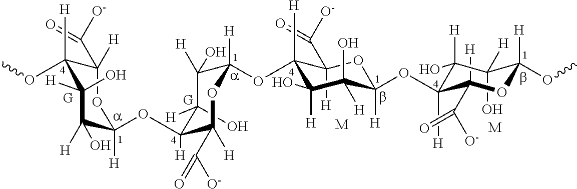

Some alginate molecules have single units of guluronic acid (or salt) alternating with single units of mannuronic acid (or salt). The ratio and distribution of the mannuronic and guluronic unit, along with the average molecular weight, affect the physical and chemical properties of the copolymer. See Haug, A. et al., Acta Chem. Scand., 183-90 (1966). Alginate polymers have viscoelastic rheological properties and other properties that make it suitable for some medical applications. See Klock, G. et al., “Biocompatibility of mannuronic acid-rich alginates,” Biomaterials, Vol. 18, No. 10, 707-13 (1997). The use of alginate as a thickener for topical ophthalmic use is disclosed in U.S. Pat. No. 6,528,465 and U.S. Patent Application Publication 2003/0232089. In U.S. Pat. No. 5,776,445, alginate is used as a drug delivery agent that is topically applied to the eye. U.S. Patent Publication No. 2003/0232089 teaches a dry-eye formulation that contains two polymer ingredients including alginate.

The alginate used in the compositions will typically have a number average molecular weight from about 20 kDa to 2000 kDa, or from about 100 kDa to about 1000 kDa, for example about 325 kDa. The concentration of alginate is from about 0.01 wt. % to about 2.0 wt. %. More, typically, the concentration of alginate is a from about 0.1 wt. % to about 0.5 wt. %.

Chitin is a naturally occurring biopolymer found in the shells of crustaceans such as shrimp, crab, and lobster, and can be isolated from these shells using aqueous solutions that are highly acidic or highly basic. It is a linear polymer formed through β-(1,4) glycosidic linkage of the monomeric N-acetyl-D-glucosamine. The chitin obtained from such sources is not normally soluble in aqueous solutions at neutral pH so various chemical modifications have been adopted to enhance the solubility of chitin. For example, chitin can be deacetylated to obtain chitosan, which is relatively soluble in aqueous compositions.

Accordingly, the compositions can include contain one or more anionic chitosan derivatives that are soluble in aqueous solutions at a pH of from 6.5-8.5. The anionic chitosan derivatives have one or more anionic functional groups, such as sulfuryl chitosan, phosphoryl chitosan, carboxymethyl chitosan, dicarboxymethyl chitosan, and succinyl chitosan. A preferred chitosan derivative is carboxymethyl chitosan. The chitosan polymers can have an average number molecular weight ranging from 1 kD to 10,000 kD.

Some of the chitosan derivatives used in the compositions are commercially available (e.g., carboxymethyl chitosan is available from KoYo Chemical Co., LTD., Tokyo, Japan); or can be prepared by means of processes that have been described in the scientific literature [e.g., Ryoichi Senju and Satoshi Okimasu, Nippon Nogeikagaku Kaishi, vol. 23, 4324-37, (1950); Keisuke Kurita, J Synthetic Organic Chemistry Japan, vol. 42, 567-574, (1984); and Seiichi Tokura, Norio Nishi, Akihiro Tsutsumi, and Oyin Somorin, Polymer J, vol. 15, 485-489 (1983)].

Other types of anionic biopolymers that can be used in the compositions include carboxymethylcellulose and salts thereof, salts of carboxymethyl and carboxymethylhydroxyethyl starchs, and other glucoaminoglycans such as chondroitin sulfate, dermatan sulfate, heparin and heparin sulfate and keratin sulfates.

It is to be understood by those in the art that the compositions can include one or more of the anionic biopolymers described above. The anionic biopolymers are present in the MPSs in a concentration from 0.005 wt. % to 1.0 wt. %, 0.005 wt. % to 0.4 wt. %, 0.005 wt. % to 0.1 wt. %, or 0.005 wt. % to 0.04 wt. %.

As stated, the compositions will also include an antimicrobial component selected from quarternary ammonium compounds (including small molecules) and polymers and low and high molecular weight biguanides. For example, biguanides include the free bases or salts of alexidine, hexamethylene biguanides and their polymers, and combinations thereof. The salts can be include either organic or inorganic anions and include gluconates, nitrates, acetates, phosphates, sulfates, halides and the like.

In a preferred embodiment, the composition will include a polymeric biguanide known as poly(hexamethylene biguanide) (PHMB or PAPB) commercially available from Zeneca, Wilmington, Del. under the trademark Cosmocil™ CQ. The PHMB is present in the compositions from 0.2 ppm to 5 ppm or from 0.5 ppm to 2 ppm.

One of the more common quaternary ammonium compounds is α[4-tris(2-hydroxyethyl)-ammonium chloride-2-butenyl]poly[1-dimethyl ammonium chloride-2-butenyl]-ω-tris(2-hydroxyethyl) ammonium chloride, also referred to in the art as polyquaternium-1. The more common guaternary ammonium compounds are generally referred to in the art as “polyquaternium” disinfectants, and are identified by a particular number following the designation such as polyquaternium-1, polyquaternium-10 or polyquaternium-42. Polyquaternium-1 is present in the MPSs from 0.5 ppm to 3 ppm.

Polyquaternium-42 is also one of the more preferred polyquaternium disinfectants, see, U.S. Pat. No. 5,300,296. Polyquaternium-42 is present in the ophthalmic compositions from; 5 ppm to 50 ppm.

It is to be understood by those in the art that the compositions can include one or more of the antimicrobial components described above. For example, in one embodiment, the ophthalmic compositions include polyquaternium-1 in combination with a biguanide antimicrobial component such as poly(hexamethylene biguanide). The polyquaternium-1 is present in relatively low concentrations, that is, from 0.5 ppm to 3 ppm, preferably from 1 ppm to 2 ppm, relative to the reported concentration of polyquaternium-1 in both Opti-Free® and Opti-Free® Replenish. Applicants believe that the polyquaternium-1 and the PHMB, in combination, may enhance the biocidal efficacy of the MPS.

In another embodiment, the ophthalmic compositions include polyquaternium-1 in combination with alexidine. The polyquaternium-1 is present in relatively low concentrations, that is, from 0.5 ppm to 3 ppm, relative to the reported concentration of polyquaternium-1 in both Opti-Free® and Opti-Free® Replenish. The alexidine is present in relatively low concentrations, that is, from 1 ppm to 4 ppm. Applicants believe that the polyquaternium-1 and the alexidine, in combination, can enhance the biocidal efficacy of the MPS.

### Contact Lens Care Compositions

The contact lens care solutions will very likely include a buffer system. By the terms “buffer” or “buffer system” is meant a compound that, usually in combination with at least one other compound, provides a buffering system in solution that exhibits buffering capacity, that is, the capacity to neutralize, within limits, either acids or bases (alkali) with relatively little or no change in the original pH. Generally, the buffering components are present from 0.05% to 2.5% (w/v) or from 0.1% to 1.5% (w/v).

The term “buffering capacity” is defined to mean the millimoles (mM) of strong acid or base (or respectively, hydrogen or hydroxide ions) required to change the pH by one unit when added to one liter (a standard unit) of the buffer solution. The buffer capacity will depend on the type and concentration of the buffer components. The buffer capacity is measured from a starting pH of 6 to 8, preferably from 7.4 to 8.4.

Borate buffers include, for example, boric acid and its salts, for example, sodium borate or potassium borate. Borate buffers also include compounds such as potassium tetraborate or potassium metaborate that produce borate acid or its salt in solutions. Borate buffers are known for enhancing the efficacy of certain polymeric biguanides. For example, U.S. Pat. No. 4,758,595 to Ogunbiyi et al, describes that a contact-lens solution containing PHMB can exhibit enhanced efficacy if combined with a borate buffer.

A phosphate buffer system preferably includes one or more monobasic phosphates, dibasic phosphates and the like. Particularly useful phosphate buffers are those selected from phosphate salts of alkali and/or alkaline earth metals. Examples of suitable phosphate buffers include one or more of sodium dibasic phosphate (Na₂HPO₄), sodium monobasic phosphate (NaH₂PO₄) and potassium monobasic phosphate (KH₂PO₄). The phosphate buffer components frequently are used in amounts from 0.01% or to 0.5% (w/v), calculated as phosphate ion.

Other known buffer compounds can optionally be added to the lens care compositions, for example, citrates, citric acid, sodium bicarbonate, TRIS, and the like. Other ingredients in the solution, while having other functions, may also affect the buffer capacity, e.g., propylene glycol or glycerin.

A preferred buffer system is based upon boric acid/borate, a mono and/or dibasic phosphate salt/phosphoric acid or a combined boric/phosphate buffer system. For example a combined boric/phosphate buffer system can be formulated from a mixture of boric acid/sodium borate and a monobasic/dibasic phosphate. In a combined boric/phosphate buffer system, the phosphate buffer is used (in total) at a concentration of 0.004 to 0.2 M (Molar), preferably 0.04 to 0.1 M. The borate buffer (in total) is used at a concentration of 0.02 to 0.8 M, preferably 0.07 to 0.2 M.

The lens care solutions can also include an effective amount of a surfactant component, in addition to the amphoteric surfactant of general formula I, a viscosity inducing or thickening component, a chelating or sequestering component, or a tonicity component. The additional component or components can be selected from materials which are known to be useful in contact lens care solutions and are included in amounts effective to provide the desired functional characteristic.

Suitable surfactants can be cationic or nonionic, and are typically present (individually or in combination) in amounts up to 2% w/v. One preferred surfactant class are the nonionic surfactants. The surfactant should be soluble in the lens care solution and non-irritating to eye tissues. Many nonionic surfactants comprise one or more chains or polymeric components having oxyalkylene (—O—R—) repeats units wherein R has 2 to 6 carbon atoms. Preferred non-ionic surfactants comprise block polymers of two or more different kinds of oxyalkylene repeat units, which ratio of different repeat units determines the HLB of the surfactant. Satisfactory non-ionic surfactants include polyethylene glycol esters of fatty acids, e.g. coconut, polysorbate, polyoxyethylene or polyoxypropylene ethers of higher alkanes (C₁₂-C₁₈). Examples of this class include polysorbate 20 (available under the trademark Tween® 20), polyoxyethylene (23) lauryl ether (Brij® 35), polyoxyethyene (40) stearate (Myrj® 52), polyoxyethylene (25) propylene glycol stearate (Atlas® G 2612). Still another preferred surfactant is tyloxapol.

A particular non-ionic surfactant consisting of a poly(oxypropylene)-poly(oxyethylene) adduct of ethylene diamine having a molecular weight from about 6,000 to about 24,000 daltons wherein at least 40 weight percent of said adduct is poly(oxyethylene) has been found to be particularly advantageous for use in cleaning and conditioning both soft and hard contact lenses. The CTFA Cosmetic Ingredient Dictionary's adopted name for this group of surfactants is poloxamine. Such surfactants are available from BASF Wyandotte Corp., Wyandotte, Mich., under Tetronic®. Particularly good results are obtained with poloxamine 1107 or poloxamine 1304. The foregoing poly(oxyethylene) poly(oxypropylene) block polymer surfactants will generally be present in a total amount from 0.0 to 2% w/v, from 0 to 1% w/v, or from 0.2 to 0.8% w/v

An analogous of series of surfactants, for use in the lens care compositions, is the poloxamer series which is a poly(oxyethylene) poly(oxypropylene) block polymers available under Pluronic® (commercially available form BASF). In accordance with one embodiment of a lens care composition the poly(oxyethylene)-poly(oxypropylene) block copolymers will have molecular weights from 2500 to 13,000 daltons or from 6000 to about 12,000 daltons. Specific examples of surfactants which are satisfactory include: poloxamer 108, poloxamer 188, poloxamer 237, poloxamer 238, poloxamer 288 and poloxamer 407. Particularly good results are obtained with poloxamer 237 or poloxamer 407. The foregoing poly(oxyethylene) poly(oxypropylene) block polymer surfactants will generally be present in a total amount from 0.0 to 2% w/v, from 0 to 1% w/v, or from 0.2 to 0.8% w/v.

The amphoteric surfactants of general formula I are surface-active compounds with both acidic and alkaline properties. The presence of the amphoteric surfactant of general formula I appears to modulate the interaction between the anionic biopolymer and cationic antimicrobial components. The amphoteric surfactants of general formula I include a class of compounds known as betaines. The betaines are characterized by a fully quaternized nitrogen atom and do not exhibit anionic properties in alkaline solutions, which means that betaines are present only as zwitterions at near neutral pH.

All betaines are characterized by a fully quaternized nitrogen. In alkyl betaines, one of the alkyl groups of the quaternized nitrogen is an alkyl chain with eight to thirty carbon atoms. One class of betaines is the sulfobetaines or hydroxysulfobetaines in which the carboxylic group of alkyl betaine is replaced by sulfonate. In hydroxysulfobetaines a hydroxy-group is positioned on one of the alkylene carbons that extend from the quaternized nitrogen to the sulfonate. In alkylamido betaines, an amide group is inserted as a link between the hydrophobic C₈-C₃₀alkyl chain and the quaternized nitrogen.

Accordingly, the invention is directed to ophthalmic compositions comprising: 0.1 ppm to 50 ppm of a cationic antimicrobial component selected from the group consisting of biguanides, polymeric biguanides, quaternium ammonium compounds and any one mixture thereof; 0.005 wt. % to 2 wt. % of an anionic biopolymer; and 0.01 wt. % to 2 wt. % of an amphoteric surfactant of general formula I

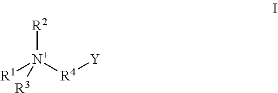

wherein R¹ is R or —(CH₂)ₙ—NHC(O)R, wherein R is a C₈-C₃₀alkyl optionally substituted with hydroxyl and n is 2, 3 or 4; R² and R³ are each independently selected from the group consisting of hydrogen and C₁-C₄alkyl; R⁴ is a C₂-C₈alkylene optionally substituted with hydroxyl; and Y is CO₂⁻ or SO₃⁻.

In one embodiment, the anioinic biopolymer is hyaluronic acid, which is present from 0.002 wt. % to 0.04 wt. %, and the cationic, antimicrobial component is poly(hexamethylene biguanide). Accordingly, one of the more preferred compositions comprises 0.5 ppm to 3.0 ppm of poly(hexamethylene biguanide); 0.002 wt. % to 0.04 wt. % hyaluronic acid; and 0.01 wt. % to 2 wt. % of an amphoteric surfactant of general formula I

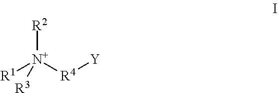

wherein R¹ is R or —(CH₂)ₙ—NHC(O)R, wherein R is a C₈-C₃₀alkyl optionally substituted with hydroxyl and n is 2, 3 or 4; R² and R³ are each independently selected from the group consisting of hydrogen and C₁-C₄alkyl; R⁴ is a C₂-C₈alkylene optionally substituted with hydroxyl; and Y is CO₂⁻ or SO₃⁻. In many embodiments, the amphoteric surfactant of general formula I is a sulfobetaine of general formula II

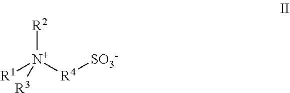

wherein R¹ is a C₈-C₃₀alkyl; R² and R³ are each independently selected from a C₁-C₄alkyl; and R⁴ is a C₂-C₈alkylene.

Certain sulfobetaines of general formula II are more preferred than others. For example, Zwitergent® 3-10 available from Calbiochem Company, is a sulfobetaine of general formula I wherein R¹ is a straight, saturated alkyl with ten (10) carbons, R² and R³ are each methyl and R⁴ is —CH₂CH₂CH₂— (three carbons, (3)). Other sulfobetaines that can be used in the ophthalmic compositions include the corresponding Zwitergent® 3-08 (R¹ is a is a straight, saturated alkyl with eight carbons), Zwitergent® 3-12 (R¹ is a is a straight, saturated alkyl with twelve carbons), Zwitergent® 3-14 (R¹ is a is a straight, saturated alkyl with fourteen carbons) and Zwitergent® 3-16 (R¹ is a is a straight, saturated alkyl with sixteen carbons). Accordingly, some of the more preferred the ophthalmic composition will include a sulfobetaine of general formula II wherein R¹ is a C₈-C₁₆alkyl and R² and R³ is methyl.

In another embodiment, the amphoteric surfactant of general formula I is a hydroxysulfobetaine of general formula III

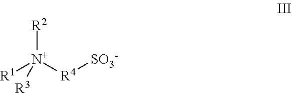

wherein R¹ is a C₈-C₃₀alkyl substituted with at least one hydroxyl; R² and R³ are each independently selected from a C₁-C₄alkyl; and R⁴ is a C₂-C₈alkylene substituted with at least one hydroxyl.

In another embodiment, the amphoteric surfactant is an alkylamido betaine of general formula IV

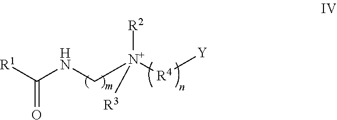

wherein R¹ is a C₈-C₃₀alkyl, and m and n are independently selected from 2, 3, 4 or 5; R² and R³ are each independently selected from a C₁-C₄alkyl optionally substituted with hydroxyl; R⁴ is a C₂-C₈alkylene optionally substituted with hydroxyl; and Y is CO₂⁻ or SO₃⁻. The most common alkylamido betaines are alkylamidopropyl betaines, e.g., cocoamidopropyl dimethyl betaine and lauroyl amidopropyl dimethyl betaine.

The lens care solutions can also include a phosphonic acid, or its physiologically compatible salt, that is represented by the following formula:

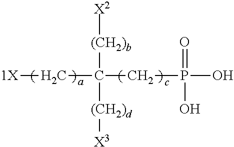

wherein each of a, b, c, and d are independently selected from integers from 0 to 4, preferably 0 or 1; X¹ is a phosphonic acid group (i.e., P(OH)₂O), hydroxy, amine or hydrogen; and X² and X³ are independently selected from the group consisting of halogen, hydroxy, amine, carboxy, alkylcarbonyl, alkoxycarbonyl, or substituted or unsubstituted phenyl, and methyl. Exemplary substituents on the phenyl are halogen, hydroxy, amine, carboxy and/or alkyl groups. A particularly preferred species is that wherein a, b, c, and d in are zero, specifically the tetrasodium salt of 1-hydroxyethylidene-1,1-diphosphonic acid, also referred to as tetrasodium etidronate, commercially available from Monsanto Company as DeQuest® 2016 diphosphonic acid sodium salt or phosphonate.

The lens care solutions can include dexpanthenol, which is an alcohol of pantothenic acid, also called Provitamin B5, D-pantothenyl alcohol or D-panthenol. It has been stated that dexpanthenol may play a role in stabilizing the lachrymal film at the eye surface following placement of a contact lens on the eye. Dexpanthenol is preferably present in the solution in an amount from 0.2 to 5%/v, from 0.5 to 3% w/v, or from 1 to 2% w/v.

The contact lens care solutions can also include a sugar alcohol such as sorbitol or xylitol. Typically, dexpanthenol is used in combination with the sugar alcohol. The sugar alcohol is present in the lens care compositions in an amount from 0.4 to 5% w/v or from 0.8 to 3% w/v.

The lens care solutions can also include one or more neutral or basic amino acids. The neutral amino acids include: the alkyl-group-containing amino acids such as alanine, isoleucine, valine, leucine and proline; hydroxyl-group-containing amino acids such as serine, threonine and 4-hydroxyproline; thio-group-containing amino acids such as cysteine, methionine and asparagine. Examples of the basic amino acid include lysine, histidine and arginine. The one or more neutral or basic amino acids are present in the compositions at a total concentration of from 0.1 to 3% w/v.

The lens care solutions can also include glycolic acid, asparatic acid or any mixture of the two at a total concentration of from 0.001% to 4% (w/v) or from 0.01% to 2.0% (w/v). In addition, the combined use of one or more amino acids and glycolic acid and/or asparatic acid can lead to a reduction in the change of the size of the contact lens due to swelling and shrinkage following placement in the lens solution.

The lens care solutions can also include one or more comfort or cushioning components, in addition to the anionic biopolymer. The comfort component can enhance and/or prolong the cleaning and wetting activity of the surfactant component and/or condition the lens surface rendering it more hydrophilic (less lipophilic) and/or to act as a demulcent on the eye. The comfort component is believed to cushion the impact on the eye surface during placement of the lens and serves also to alleviate eye irritation.

Suitable comfort components include, but are not limited to, water soluble natural gums, cellulose-derived polymers and the like. Useful natural gums include guar gum, gum tragacanth and the like. Useful cellulose-derived comfort components include cellulose-derived polymers, such as hydroxypropyl cellulose, hydroxypropylmethyl cellulose, carboxymethyl cellulose, methyl cellulose, hydroxyethyl cellulose and the like. A very useful comfort component is hydroxypropylmethyl cellulose (HPMC). Some non-cellulose comfort components include propylene glycol or glycerin. The comfort components are typically present in the solution from 0.01% to 1% (w/v).

One preferred comfort agent that is believed to maintain a hydrated corneal surface is polyvinylpyrrolidone (PVP). PVP is a linear homopolymer or essentially a linear homopolymer comprising at least 90% repeat units derived from 1-vinyl-2-pyrrolidone monomer, the remainder of the monomer composition can include neutral monomer, e.g., vinyl or acrylates. Other synonyms for PVP include povidone, polyvidone, 1-vinyl-2-pyrrolidinone, and 1-ethenyl-2-pyrolionone (CAS registry number 9003-39-8). The PVP will preferably have a weight average molecular weight from 10,000 to 250,000 or from 30,000 to 100,000. Such materials are sold by various companies, including ISP Technologies, Inc. under the trademark PLASDONE® K-29/32, from BASF under the trademark KOLLIDON®, for example, KOLLIDON® K-30 or K-90. It is also preferred that one use pharmaceutical grade PVP.

The lens care solutions can also include one or more chelating components to assist in the removal of lipid and protein deposits from the lens surface following daily use. Typically, the ophthalmic compositions will include relatively low amounts, e.g., from 0.005% to 0.05% (w/v) of ethylenediaminetetraacetic acid (EDTA) or the corresponding metal salts thereof such as the disodium salt, Na₂EDTA.

One possible alternative to the chelator Na₂EDTA or a possible combination with Na₂EDTA, is a disuccinate of formula IV below or a corresponding salt thereof;

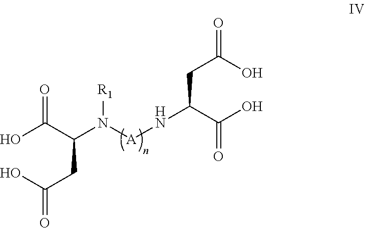

wherein R₁ is selected from hydrogen, alkyl or —C(O)alkyl, the alkyl having one to twelve carbons and optionally one or more oxygen atoms, A is a methylene group or an oxyalkylene group, and n is from 2 to 8. In one embodiment, the disuccinate is S,S-ethylenediamine disuccinate (S,S-EDDS) or a corresponding salt thereof. One commercial source of S,S-EDDS is represented by Octaquest® E30, which is commercially available from Octel. The chemical structure of the trisodium salt of S,S-EDDS is shown below. The salts can also include the alkaline earth metals such as calcium or magnesium. The zinc or silver salt of the disuccinate can also be used in the ophthalmic compositions.

Still another class of chelators include alkyl ethylenediaminetriacetates such as nonayl ethylenediaminetriacetate. See, U.S. Pat. No. 6,995,123 for a more complete description of such agents.

The lens care solutions will typically include an effective amount of a tonicity adjusting component. Among the suitable tonicity adjusting components that can be used are those conventionally used in contact lens care products such as various inorganic salts. Sodium chloride and/or potassium chloride and the like are very useful tonicity components. The amount of tonicity adjusting component is effective to provide the desired degree of tonicity to the solution.

The lens care solutions will typically have an osmolality in the range of at least about 200 mOsmol/kg for example, about 300 or about 350 to about 400 mOsmol/kg. The lens care solutions are substantially isotonic or hypertonic (for example, slightly hypertonic) and are ophthalmically acceptable.

One exemplary multipurpose solution prepared with the components and amounts of each listed in Table 2.

TABLE 2

| | Minimum | Maximum | Preferred |
|---|---|---|---|
| Component | Amount (wt. %) | Amount (wt. %) | Amount (wt. %) |
| boric acid | 0.10 | 1.0 | 0.64 |
| sodium borate | 0.01 | 0.20 | 0.1 |
| anionic biopolymer | 0.005 | 0.05 | 0.01 |
| poloxamine/poloxamer | 0.05 | 2.0 | 1.00 |
| PHMB | 0.5 ppm | 2 ppm | 1 ppm |

Another multipurpose solution includes the following components and amounts of each listed in Table 3.

TABLE 3

| | Minimum | Maximum | Preferred |
|---|---|---|---|
| Component | Amount (wt. %) | Amount (wt. %) | Amount (wt. %) |
| poloxamine/poloxamer | 0.01 | 0.2 | 0.05 |
| boric acid | 0.1 | 1.0 | 0.60 |
| sodium borate | 0.01 | 0.2 | 0.10 |
| anionic biopolymer | 0.005 | 0.03 | 0.01 |
| polyquaternium-1 | 0.5 ppm | 3 ppm | 1 ppm |

Another multipurpose solution includes the following components and amounts of each listed in Table 4.

TABLE 4

| | Minimum | Maximum | Preferred |
|---|---|---|---|
| Component | Amount (wt. %) | Amount (wt. %) | Amount (wt. %) |
| poloxamine/poloxamer | 0.01 | 0.2 | 0.05 |
| boric acid | 0.1 | 1.0 | 0.60 |
| sodium borate | 0.01 | 0.2 | 0.10 |
| hyaluronic acid | 0.005 | 0.03 | 0.01 |
| polyquaternium-1 | 0.5 ppm | 3 ppm | 1 ppm |
| PHMB | 0.5 ppm | 2 ppm | 1 ppm |

Another multipurpose solution includes the following components and amounts of each listed in Table 5.

TABLE 5

| | Minimum | Maximum | Preferred |
|---|---|---|---|
| Component | Amount (wt. %) | Amount (wt. %) | Amount (wt. %) |
| poloxamine/poloxamer | 0.01 | 0.2 | 0.05 |
| boric acid | 0.1 | 1.0 | 0.60 |
| sodium borate | 0.01 | 0.2 | 0.10 |
| anionic biopolymer | 0.005 | 0.03 | 0.01 |
| polyquaternium-1 | 0.5 ppm | 3 ppm | 1 ppm |
| alexidine | 1 ppm | 4 ppm | 3 ppm |

As described, the MPSs can be used to clean and disinfect contact lenses. In general, the contact lens solutions can be used as a daily or every other day care regimen known in the art as a “no-rub” regimen. This procedure includes removing the contact lens from the eye, rinsing both sides of the lens with a few milliliters of solution and placing the lens in a lens storage case. The lens is then immersed in fresh solution for at least two hours. The lens is the removed form the case, optionally rinsed with more solution, and repositioned on the eye.

Alternatively, a rub protocol would include each of the above steps plus the step of adding a few drops of the solution to each side of the lens, followed by gently rubbing the surface between ones fingers for approximately 3 to 10 seconds. The lens can then be, optionally rinsed, and subsequently immersed in the solution for at least two hours. The lenses are removed from the lens storage case and repositioned on the eye.

The MPSs can be used with many different types of contact lenses including: (1) hard lenses formed from materials prepared by polymerization of acrylic esters, such as poly(methyl methacrylate) (PMMA), (2) rigid gas permeable (RGP) lenses formed from silicone acrylates and fluorosilicone methacrylates, (3) soft, hydrogel lenses, and (4) non-hydrogel elastomer lenses.

As an example, soft hydrogel contact lenses are made of a hydrogel polymeric material, a hydrogel being defined as a crosslinked polymeric system containing water in an equilibrium state. In general, hydrogels exhibit excellent biocompatibility properties, i.e., the property of being biologically or biochemically compatible by not producing a toxic, injurious or immunological response in a living tissue. Representative conventional hydrogel contact lens materials are made by polymerizing a monomer mixture comprising at least one hydrophilic monomer, such as (meth)acrylic acid, 2-hydroxyethyl methacrylate (HEMA), glyceryl methacrylate, N,N-dimethacrylamide, and N-vinylpyrrolidone (NVP). In the case of silicone hydrogels, the monomer mixture from which the copolymer is prepared further includes a silicone-containing monomer, in addition to the hydrophilic monomer. Generally, the monomer mixture will also include a crosslink monomer such as ethylene glycol dimethacrylate, tetraethylene glycol dimethacrylate, and methacryloxyethyl vinylcarbonate. Alternatively, either the silicone-containing monomer or the hydrophilic monomer may function as a crosslink agent.

The MPSs can also be formulated as a contact lens rewetting eye drop solution. By way of example, the rewetting drops may be formulated according to any one of the foregoing formulations of Tables 2 to 5 above. Alternatively, the formulations may be modified by increasing the amount of surfactant; by reducing the amount of antimicrobial agent to a preservative amount and/or by adding a humectant and/or demulcent.

The MPSs can be used as a preservative in formulations for treating patients with dry eye. In such a method, the ophthalmic composition is administered to the patient's eye, eye lid or to the skin surrounding the patient's eye. The compositions can be administered to the eyes irrespective of whether contact lenses are present in the eyes of the patient. For example, many people suffer from temporary or chronic eye conditions in which the eye's tear system fails to provide adequate tear volume or tear film stability necessary to remove irritating environmental contaminants such as dust, pollen, or the like.

The MPSs can also be used as a preservative in pharmaceutical compositions such as ear and eye drops, and prescription and over-the-counter formulations containing a pharmaceutical active that are used or administered over time such as a cream, ointment, gel or solution.

In many instances, the ophthalmic compositions will include one or more active pharmaceutical agents. Generally, the active pharmaceutical agent is in one or more classes of ocular pharmaceuticals including, but not limited to anti-inflammatory agents, antibiotics, immunosuppressive agents, antiviral agents, antifungal agents, anesthetics and pain killers, anticancer agents, anti-glaucoma agents, peptide and proteins, anti-allergy agents.

### EXAMPLES AND TESTING

A MPS was prepared using the following process (components are listed in wt. % unless noted in ppm). A volume of purified water equivalent to 85-90% of the total batch weight is added to a stainless steel mixing vessel. The following batch quantities of components are added to the water with stirring in the order listed: sodium chloride, edetate disodium, boric acid, sodium borate and poloxamine 1107. The solution is mixed (stirred) for not less than 10 minutes to ensure complete dissolution of each of the components. The solution is warmed to a temperature not less than 70° C. and the sodium hyaluronate is added. The warmed solution is stirred for at least 20 minutes until the sodium hyaluronate appears to be completely dissolved. The pH of the resulting solution is measured at room temperature, and if necessary, the pH is adjusted with 1N NaOH or 1N HCl (target pH=7.5). The solution is then heat sterilized at 121° C. for at least 30 minutes.

In a second stainless steel vessel, a measured amount of sulfobetaine 3-10 required for the batch is added to a given amount of purified water, and the solution stirred for at least 30 minutes. The sulfobetaine solution is aseptically transferred to the bulk solution through a sterilizing filter, and again the solution is stirred for at least 10 minutes.

In a third stainless steel vessel, a measured amount of PAPB required for the batch is added to a given amount of purified water, and the solution is stirred for at least 10 minutes. The PAPB solution is aseptically transferred to the bulk solution through a sterilizing filter, and again the solution is stirred for at least 10 minutes.

In a fourth stainless steel vessel, a measured amount of polyquaternium-1 required for the batch is added to a given amount of purified water, and the solution is stirred for at least 10 minutes. The polyquaternium-1 solution is aseptically transferred to the bulk solution through a sterilizing filter, and again the solution is stirred for at least 10 minutes. Purified water is then added to the bulk solution to bring to the batch weight. The final solution is stirred for at least 15 minutes. The MPS had the following component concentrations.

### Example 1

A MPS is provided below with the components provided in wt. % unless noted as ppm.

| | Example 1 |
|---|---|
| Component | (MPS A) |
| boric acid | 0.64 |
| sodium borate | 0.11 |
| Na₂EDTA | 0.025 |
| Tetronic ® 1107 | 1.0 |
| Na hyaluronic acid ^{a} | 0.01 |
| PHMB (ppm) | 1.3 |
| polyquaternium-1 (ppm) | 1.0 |
| sulfobetaine 3-10 | 0.05 |
| sodium chloride | 0.5 |

### Examples 2 to 5

TABLE 6

| Example No. | 2 | 3 | 4 | 5 |
|---|---|---|---|---|
| poloxamine/poloxamer | 0.5 | 0.5 | 0.5 | 0.5 |
| boric acid | 0.45 | 0.45 | 0.6 | 0.45 |
| sodium borate | 0.12 | 0.12 | 0.12 | 0.12 |
| citric acid | 0.1 | 0.1 | — | 0.1 |
| anionic biopolymer | 0.02 | 0.02 | 0.02 | 0.02 |
| polyquaternium-1 (ppm) | 1.5 | 1.5 | — | 1.0 |
| PHMB (ppm) | 0.8 | — | 0.8 | 1.1 |
| alexidine (ppm) | — | 3.0 | 2.0 | — |

### Comparative Multipurpose Lens Care Solutions

Currently marketed MPSs were used as comparative examples in many of the tests that follow. MPS B, AQuify®, Ciba Vision, (Duluth, Ga.); MPS C, COMPLETE® MPS Easy Rub, AMO, (Santa Ana, Calif.); MPS D, OPTI-FREE® Express, Alcon, (Fort Worth, Tex.); and MPS E; OPTI-FREE® RepleniSH, (Alcon) were obtained commercially and used within their expiration dates.

### Human Corneal Epithelial SV40 Transformed Cell Line

The original human corneal epithelial SV40 transformed cell line was obtained from Dr. Araki-Sasaki (Ideta Eye Hospital, Kumamoto, Japan), See, McCanna D. J. et al. in Use of a human corneal epithelial cell line for screening the safety of contact lens care solutions in vitro. Eye Contact Lens 2008, 34, 6. Cells were grown in 50/50 Ham's F12/Dulbecco's modified Eagle's medium (DMEM) containing 10% fetal bovine serum in an incubator at 37° C., 5% CO₂, and 95% humidity. Tissue culture media and reagents were from Invitrogen (Carlsbad, Calif.). All other reagents were purchased from standard commercial sources.

### ZO-1 Immunostaining

HCEpiC cells were seeded in 4-well tissue culture-treated chamber slides at a density of 1×10⁴ per well and cultured until 100% confluent. One day after becoming confluent, culture medium was removed by aspiration and cells were treated with the MPS for 30 min. Cells were then fixed for 10 min in 1:1-20° C. methanol/acetone, blocked with 1% bovine serum albumin plus 10% normal goat serum in PBS and then incubated in ZO-1 antibody (1:100, Millipore, Billerica, Mass.) for 2 h. After washing, cells were incubated in secondary antibody at 1:3000 (Alexafluor rabbit 488, Millipore) for 1 h. Cells were washed 3×10 min in PBS and mounted using 1 drop of vectashield with propidium iodide (Vector Labs, Burlingame, Calif.). The cells were viewed using an Olympus confocal microscope (Fluoview 1000) at 40× magnification.

### Transepithelial Electrical Resistance

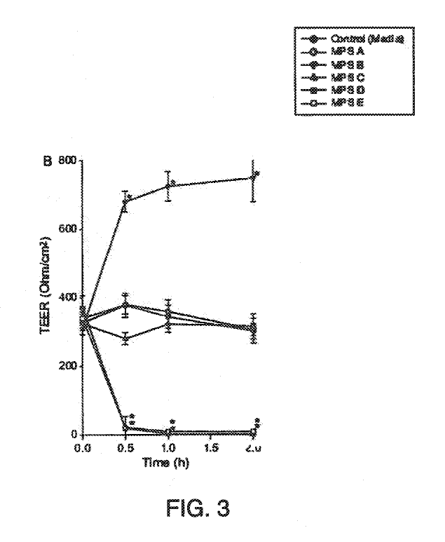

HCEpiC were seeded on 12-mm Transwell Costar clear culture inserts (Corning, Corning, N.Y.) at 10⁴ cells per insert and cultured for 5-7 days. After becoming confluent (approx. 3 days) TEER was monitored daily and the experiment was performed when TEER was above 200Ω/cm² (5 to 7 days after seeding), indicating tight junction formation. Cells were then exposed to MPS in media at 50% and 75% (data plotted as FIG. 3) (diluted in complete media, DMEM/F12 for 30, 60 and 120 min, and TEER was determined at time 0 and at each time point after exposure to MPSs. TEER was monitored using an EndOhm cup connected to a volt ohmmeter. * indicates significantly different from control at the same time point, P<0.05.

### Electric Cell-Substrate Impedance Sensing (ECIS)

The ECIS system (model 1600ZΦ) used in this study was from Applied BioPhysics (Troy, N.Y.). In ECIS, cells are grown on a small gold film electrode deposited on the bottom of a tissue culture well, and a much larger counter electrode completes the circuit by using standard tissue culture medium as an electrolyte. A weak (<1 μA) ac signal (usually in the frequency range from 1 to 40 kHz) is applied to the system. The cells cause substantial changes in the system's impedance, and these impedance values can be converted to resistance values. See, Lo, C M et al., Biophys. J. 1995, 69, 2800, and Giaver I, Keese C R, Proc. Natl. Acad. Sci. USA 1991, 88, 7896. Cells were seeded on ECIS 8-well electrode arrays (8W10E) in DMEM/F12 medium containing 10% FBS (DMEM/F12 complete medium) (0.25 ml/well) at a density of 5×10⁴ per well and cultured until reaching confluence in an incubator at 37° C., 5% CO₂, and 95% humidity. Culture medium was removed by aspiration and cells were incubated in DMEM/F12 complete medium diluted with MPSs at a 1:1 ratio. Cells were cultured under these conditions and the change in electrical resistance was monitored by ECIS for 2 h at 20 min intervals at 3 kHz. One well of cells on each slide was tested with 50% PBS as negative control.

The following tests were performed with three repeats and data were verified in at least two independent experiments. TEER (Ω/cm²) was calculated by dividing the measured resistance by the area of the transwell filter (1.12 cm²). Background resistance caused by the filter alone was subtracted from the experimental values. Statistical analysis on each MPS dose was analyzed using a two-way ANOVA followed by the Tukey-Kramer post-hoc comparison test (JMP 8 software, SAS Institute, Cary, N.C.) comparing the MPS treated TEER with control TEER at each time point, and P<0.05 was considered statistically significant. Data are expressed as means±SD.

For ECIS, statistical evaluation was conducted by a two-way ANOVA with repeated measures followed by the Tukey-Kramer test. Integrated responses of the change in resistance were analyzed by calculating the areas under the curve (AUC) for each test well over the time course using the trapezoidal rule, which is defined by the equation Σ(Time (Hr) n)−(n−1))×(Resistance (Ohms) n+n−1)/2=Ohms*Hr. Integrated responses were analyzed by a one-way ANOVA followed by the Tukey-Kramer test. Data were expressed as means±SEM. Cells were grown on ECIS electrode arrays (8W10E) and monolayer resistance of cells treated with 50% PBS (control) or MPSs were monitored by ECIS at 3 kHz over a 2-h time course. Time course of monolayer resistance. * indicates significantly different from control at the same time point, P<0.05.

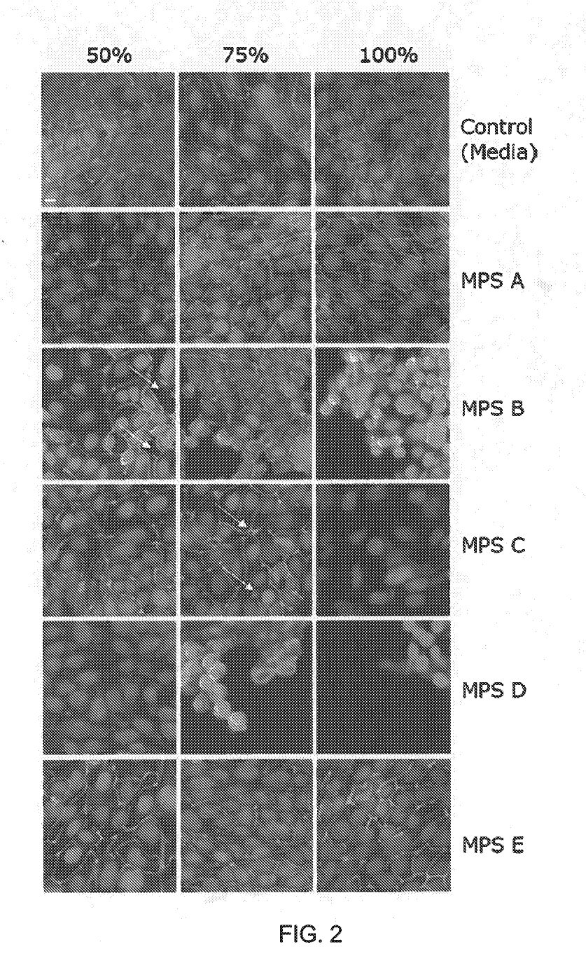

FIG. 2 shows the effect of the MPSs on ZO-1 distribution in HCEpiC. The tested MPSs were diluted in DMEM/F12 complete medium to the concentrations shown, and cells were treated for 30 min. Arrows indicate disrupted intercellular junctions. ZO-1 immunostaining was continuous and linear in control HCEpiC with clear intercellular junctions evident. Overall, HCEpiC exposed to all concentrations of MPS A and MPS E appeared similar to control. In contrast, cells exposed to MPS B, MPS C, and MPS D had varying levels of disruption to the ZO-1 staining. With exposure of HCEpiC to MPS B, intercellular junctions showed some opening at the 50% solution, and cell detachment at 75% and 100% solutions. With exposure of HCEpiC to MPS C, ZO-1 staining was similar to control at 50% MPS, opening of the intercellular junctions was observed with the 75% solution, and cell detachment occurred at the 100% solution concentration. Exposure of HCEpiC to MPS D resulted in opening of the intercellular junctions, fainter ZO-1 staining, and cell detachment at all three concentrations of solution tested (FIG. 2).

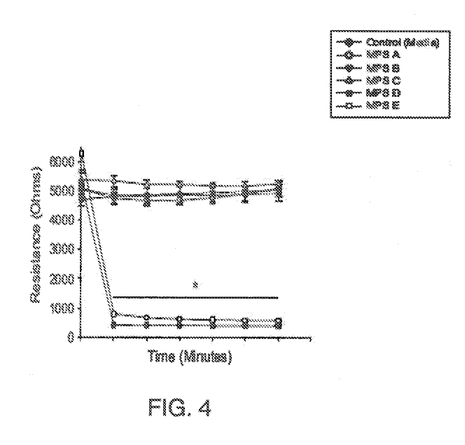

As a quantitative assessment of barrier function, measurements of monolayer resistance after exposure to 50% and 75% MPS across HCEpiC were made by TEER and ECIS. Both MPS D and MPS E significantly decreased TEER after 30 min of exposure at both concentrations and this effect was also observed at the 60 and 120 min time points. In contrast, MPS B increased TEER after 30 min exposure and TEER was also elevated at the 60 and 120 min time points. Neither MPS A nor MPS C altered TEER after 0.5, 1, or 2 h exposure times as compared to control (FIG. 3). Time courses of monolayer resistance as measured using ECIS for each individual treatment are shown in FIG. 4. Two-way ANOVA repeated measures analysis revealed that MPS D and MPS E were different from all groups after 20 min. In contrast, resistance of HCEpiC cells exposed to MPS A, MPS B and MPS C, were not significantly different from control at any time point. One-way ANOVA analysis of the integrated responses, calculated by determining area under the curve, indicated that both MPS D and MPS E significantly reduced the integrated resistance of HCEpiC monolayer over the 2-h time course when compared to control, as well as compared to other MPSs.

Based in-part on the on the three independent complementary methods described above; (1) immunostaining for the tight junction protein ZO-1, (2) measurement of monolayer resistance of HCEpiC grown on transwells and (3) ECIS electrode arrays MPS A, or Example 1, does not disrupt corneal barrier function. In contrast, all four of the current marketed MPSs (i.e., MPS B, MPS C, MPS D and MPS E) had, to varying degrees, some effect on corneal barrier function. Immunostaining for ZO-1 demonstrated the effect of MPSs on the structural integrity of the tight junction complex. Monolayer resistance assessed barrier function and was measured in two different ways. Resistance was measured across HCEpiC grown on permeable supports, which has the advantage that the cells form a tight monolayer more relevant to the in vivo situation. ECIS has the advantage a high sensitivity and also of non-invasively monitoring resistance in real time.

MPS D had the greatest effect on barrier function, causing disruption of ZO-1 staining, a decrease in resistance as measured by TEER and ECIS. With MPS E, ZO-1 staining overall was intact was similar to control, however, the two quantitative measures of monolayer resistance indicated a significant decrease in barrier function. This may be explained by the fact that resistance measurements will be affected by even very small infrequent disruptions to the monolayer, which may not be readily apparent using the microscopy techniques. A previously published study examined the effect of MPS E and showed disruption of tight junctions though to a lesser extent than MPS D, which is similar to the findings of the current study. See, Chuang E. Y. et al. in Effects of contact lens multipurpose solutions on human corneal epithelial survival and barrier function. Eye Contact Lens 2008, 34, 281.

### Biocidal Stand-Alone Stability

In order to assess the activity of the formulation, samples are bottled in 4 oz PET containers and stored at ambient temperature, as well as elevated temperatures for a given period. The stand-alone biocidal efficacy of the samples is tested at designated intervals to determine the stability of the formulation with time for is disinfection activity. The “Stand-Alone Procedure for Disinfecting Products” is based on the Disinfection Efficacy Testing for Products dated May 1, 1997, prepared by the U.S. Food and Drug Administration, Division of Ophthalmic Devices. This performance requirement does not contain a rub procedure.

The stand-alone test challenges a disinfecting product with a standard inoculum of a representative range of microorganisms and establishes the extent of viability loss at predetermined time intervals comparable with those during which the product may be used. The primary criteria for a given disinfection period (corresponding to a potential minimum recommended disinfection period) is that the number of bacteria recovered per mL must be reduced by a mean value of not less than 3.0 logs within the given disinfection period. The number of mold and yeast recovered per ml must be reduced by a mean value of not less than 1.0 log within the minimum recommended disinfection time with no increase at four times the minimum recommended disinfection time.

The antimicrobial efficacy of each of the various compositions for the chemical disinfection and cleaning of contact lenses are evaluated in the presence of 10% organic soil using the stand-alone procedure. Microbial challenge inoculums are prepared using Staphylococcus aureus (ATCC 6538), Pseudomonas aeruginosa (ATCC 9027), Serratia marcescens (ATCC 13880), Candida albicans (ATCC 10231) and Fusarium solani(ATCC 36031). The test organisms are cultured on appropriate agar and the cultures are harvested using sterile Dulbecco's Phosphate Buffered Saline plus 0.05 percent weight/volume polysorbate 80 (DPBST) or a suitable diluent and transferred to a suitable vessel. Spore suspensions are filtered through sterile glass wool to remove hyphal fragments. Serratia marcescens, as appropriate, is filtered through a 1.2 μm filter to clarify the suspension.

After harvesting, the suspension is centrifuged at no more than 5000 ×g for a maximum of 30 minutes at a temperature of 20° C. to 25° C. The supernatant is decanted and resuspended in DPBST or other suitable diluent. The suspension is centrifuged a second time, and resuspended in DPBST or other suitable diluent. All challenge bacterial and fungal cell suspensions are adjusted with DPBST or other suitable diluent to 1×10⁷ to 1×10⁸ cfu/mL. The appropriate cell concentration may be estimated by measuring the turbidity of the suspension, for example, using a spectrophotometer at a preselected wavelength, for example, 490 nm. One tube is prepared containing a minimum of 10 mL of test solution per challenge organism. Each tube of the solution to be tested is inoculated with a suspension of the test organism sufficient to provide a final count of 1×10⁵ to 1×10⁶ cfu/mL, the volume of the inoculum not exceeding 1 percent of the sample volume. Dispersion of the inoculum is ensured by vortexing the sample for at least 15 seconds. The inoculated product is stored at 10° C. to 25° C. Aliquots in the amount of 1.0 mL are taken of the inoculated product for determination of viable counts after certain time periods of disinfection.

The suspension is mixed well by vortexing vigorously for at least 5 sec. The 1.0 mL aliquots removed at the specified time intervals are subjected to a suitable series of decimal dilutions in validated neutralizing media. The suspensions are mixed vigorously and incubated for a suitable period of time to allow for neutralization of the microbial agent. The viable count of organisms is determined in appropriate dilutions by preparation of triplicate plates of trypticase soy agar (TSA) for bacteria and Sabouraud dextrose agar (SDA) for mold and yeast. The bacterial recovery plates are incubated at 30° C. to 35° C. for two to four days. The yeast recovery plates are incubated at 20° C. to 30° C. for two to four days. The mold recovery plates are incubated at 20° C. to 25° C. for three to seven days. The average number of colony forming units is determined on countable plates. Countable plates refer to 30 to 300 cfu/plates for bacteria and yeast, and 8 to 80 cfu/plate for mold except when colonies are observed only for the 10⁰ or 10⁻¹ dilution plates. The microbial reduction is then calculated at the specified time points.

In order to demonstrate the suitability of the medium used for growth of the test organisms and to provide an estimation of the initial inoculum concentration, inoculum controls are prepared by dispersing an identical aliquot of the inoculum into a suitable diluent, for example, DPBST, using the same volume of diluent used to suspend the organism as listed above. Following inoculation in a validated neutralizing broth and incubation for an appropriate period of time, the inoculum control must be between 1.0×10⁵ and 1.0×10⁶ cfu/mL.

An evaluation was conducted to determine the disinfection efficacy profile each of the MPSs including MPS A (Example 1) presently sold in the United States: Opti-Free® Express, April-June 2010; Opti-Free® Replenish, October-December 2009; Complete® Easy Rub, February-March 2010; and Aquify®, July-October 2010. Three separate product samples were used for each competitor lens care solution and three separate laboratory lots were used for the formulation of Example 1, April 2010. The expiration dates for each lens care solution product is also provided. To the best of our knowledge, each of the products from the major competitors has a 24 month shelf-life. The average 4-hour, stand-alone biocidal data of the three product samples against each microbe is represented in the bar chart of FIG. 1.

Example 1 (MPS A) and MPS D were the only multipurpose lens care solutions that passed the ISO regulatory standards for all five microbes. Biocidal data for MPS E is within the experimental error for passing the ISO standard, though the average falls below the standard. Moreover, Example 1 surpassed MPS D against Candida albicans by about 1 log reduction, which indicates that the formulation of Example 1 is over 10× more active against this fungi.

We claim:

1. A multipurpose lens care solution comprising:
0.005 wt. % to 1 wt. % of an anionic biopolymer; and
an antimicrobial component selected from the group consisting of 0.5 ppm to 2 ppm of poly(hexamethylene biguanide), 0.5 ppm to 3 ppm of polyquaternium-1, 1 ppm to 4 ppm of alexidine and any one mixture thereof; wherein the ZO-1 immunostaining of HCEpiC is similar to phosphate buffered saline after thirty minutes of contact time with the solution; and the transepithelial electrical resistance (TEER) of HCEpiC exhibits a 25% difference or less than phosphate buffered saline in Ohm/cm² after one hour of contact time with a 3:1 dilution (solution:DMEM), or the ECIS electrode arrays exhibit a 25% difference or less than phosphate buffered saline in Ohm after one hour of contact time with a 1:1 dilution (solution:DMEM).

2. The solution of claim 1 wherein the antimicrobial component is 0.5 ppm to 2 ppm of poly(hexamethylene biguanide).

3. The solution of claim 2 wherein the anionic biopolymer is hyaluronic acid, which is present from 0.002 wt. % to 0.04 wt. %.

4. The solution of claim 2 comprising 0.01 wt. % to 1 wt. % of the amphoteric surfactant of general formula I. 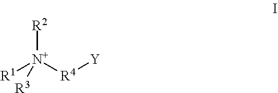
wherein R¹ is R or —(CH₂)ₙ—NHC(O)R, wherein R is a C₈-C₃₀alkyl optionally substituted with hydroxyl and n is 2, 3 or 4; R² and R³ are each independently selected from the group consisting of hydrogen and C₁-C₄alkyl; R⁴ is a C₂-C₈alkylene optionally substituted with hydroxyl; and Y is CO₂⁻ or SO₃⁻.

5. The solution of claim 4 wherein R¹ is R; R² and R³ are each independently selected from a C₁-C₂alkyl; R⁴ is a C₂-C₄alkylene and Y is SO₃⁻.

6. The solution of claim 2 further comprising α[4-tris(2-hydroxyethyl)-ammonium chloride-2-butenyl]poly[1-dimethyl ammonium chloride-2-butenyl]-ω-tris(2-hydroxyethyl) ammonium chloride, which is present from 1 ppm to 2 ppm.

7. The solution of claim 1 further comprising propylene glycol, hydroxypropylmethyl cellulose or hydroxypropyl guar.

8. The solution of claim 2 wherein the solution exhibits a biocidal profile against Candida albicans of at least 2 log reduction in the presence of 10% organic soil using the “Stand-Alone Procedure for Disinfecting Products” dated May 1, 1997 of the U.S. Food and Drug Administration.

9. The solution of claim 2 wherein the transepithelial electrical resistance (TEER) of HCEpiC exhibits a 10% difference or less than phosphate buffered saline in Ohm/cm² after one hour of contact time with a 3:1 dilution (solution:DMEM), or the ECIS electrode arrays exhibit a 10% difference or less than phosphate buffered saline in Ohm after one hour of contact time with a 1:1 dilution (solution:DMEM).

10. The solution of claim 1 wherein the antimicrobial component is 0.5 ppm to 3 ppm of polyquaternium-1.

11. The solution of claim 10 wherein the anionic biopolymer is hyaluronic acid, which is present from 0.002 wt. % to 0.04 wt. %.

12. The solution of claim 10 further comprising poly(hexamethylene biguanide), which is present from 0.5 ppm to 2 ppm.

13. The solution of claim 10 further comprising citrate, citric acid or a mixture thereof.

14. The solution of claim 10 further comprising propylene glycol, hydroxypropylmethyl cellulose or hydroxypropyl guar.

15. The solution of claim 12 wherein the solution exhibits a biocidal profile against Candida albicans of at least 2 log reduction in the presence of 10% organic soil using the “Stand-Alone Procedure for Disinfecting Products” dated May 1, 1997 of the U.S. Food and Drug Administration.

16. The solution of claim 10 wherein the transepithelial electrical resistance (TEER) of HCEpiC exhibits a 10% difference or less than phosphate buffered saline in Ohm/cm² after one hour of contact time with a 3:1 dilution (solution:DMEM), or the ECIS electrode arrays exhibit a 10% difference or less than phosphate buffered saline in Ohm after one hour of contact time with a 1:1 dilution (solution:DMEM).

17. The solution of claim 1 wherein the antimicrobial component is 1 ppm to 4 ppm of alexidine.

18. The solution of claim 17 wherein the anionic biopolymer is hyaluronic acid, which is present from 0.002 wt. % to 0.04 wt. %.

19. The solution of claim 17 further comprising poly(hexamethylene biguanide), which is present from 0.5 ppm to 2 ppm, or polyquaternium-1, which is present from 1 ppm to 3 ppm.

20. The solution of claim 19 wherein the solution exhibits a biocidal profile against Candida albicans of at least 2 log reduction in the presence of 10% organic soil using the “Stand-Alone Procedure for Disinfecting Products” dated May 1, 1997 of the U.S. Food and Drug Administration.

21. The solution of claim 19 wherein the transepithelial electrical resistance (TEER) of HCEpiC exhibits a 10% difference or less than phosphate buffered saline in Ohm/cm² after one hour of contact time with a 3:1 dilution (solution:DMEM), or the ECIS electrode arrays exhibit a 10% difference or less than phosphate buffered saline in Ohm after one hour of contact time with a 1:1 dilution (solution:DMEM).

22. A method of cleaning and disinfecting a contact lens, the method comprising soaking the contact lens in the multipurpose lens care solution of claim 1 for at least two hours.

23. A method of cleaning and disinfecting a contact lens, the method comprising soaking the contact lens in the multipurpose lens care solution of claim 10 for at least two hours.

24. A method of cleaning and disinfecting a contact lens, the method comprising soaking the contact lens in the multipurpose lens care solution of claim 17 for at least two hours.
